(19) United States
(12) Patent Application Publication
(10) Pub. No.: US 2013/0276515 A1
(43) Pub. Date: Oct. 24, 2013

(54) MEASURING DEVICE FOR DUST IN FLUE GAS

(71) Applicant: STEAG POWITEC GMBH, Essen (DE)

(72) Inventor: Franz WINTRICH, Essen (DE)

(73) Assignee: STEAG Powitec GmbH, Essen (DE)

(21) Appl. No.: 13/867,306

(22) Filed: Apr. 22, 2013

(30) Foreign Application Priority Data
Apr. 23, 2012 (DE) 10 2012 103 563.6

(51) Int. Cl. G01N 1/22

(52) U.S. Cl. CPC G01N 1/2202
USPC 73/28.04

(57) ABSTRACT

A measuring device (10) for dust (S₀) in flue gas, includes a housing (10) and at least one sensor (45) arranged in the housing (11) for obtaining measuring data of the withdrawn sample. During operation, samples of the dust (S₀) can be taken continuously. The sensor (45) is sensitive for gas (G), which arrives in the housing (11) accumulated on the dust (S₁).

### CROSS REFERENCE TO RELATED APPLICATIONS

This application claims the benefit of priority under 35 U.S.C. §119 of German Patent Application DE 10 2012 103 563.6 filed Apr. 23, 2012, the entire contents of which are incorporated herein by reference.

### FIELD OF THE INVENTION

The invention relates to a measuring device for dust in flue gas, by means of which samples of the dust can be taken, with a housing and with at least one sensor arranged in the housing for obtaining measuring data of the withdrawn sample.

### BACKGROUND OF THE INVENTION

From EP 2 215 448 B1 a measuring device of the abovementioned type for flue gas is known. From the combustion chamber of a power plant the flue gas is led towards the chimney by means of a channel. The measuring device is arranged on the outside of the channel wall. An inlet tube of the measuring device, which penetrates the channel wall, is equipped with an open end directed against the flow, by which it withdraws flue gas from the channel and leads it into the interior of the measuring device. By means of a (centrifugal) separator the dust, particularly fly ash, is separated from the gas, which by means of an outlet pipe that penetrates the channel wall is led back into the channel. The dust reaches, through a valve, a chamber. When a certain filling level is reached, the valve closes, and the dust is exposed a microwave field, the attenuation of which is measured. By applying compressed air the dust is compressed. Again with the microwave field a similar measuring is done. By means of the measuring data the carbon content of the dust is determined. After that the dust is blown alternatively into a collecting container or through the outlet tube into the channel.

The DE 37 41 390 C2 describes a measuring device for flue gas, which is used in a denitration plant of a large combustion plant. The measuring device presents a housing and a probe displaceable within it, which can take samples at various parts of a flue gas channel. For separating ammonia and sulphur oxides the probe contains a (cyclone) separator with downstream filters and a condenser with cooling. In support of the cyclone function a blower sucks a partial flow of the flue gas from the separator and leads it back into the flue gas channel. Moreover the probe contains a heating and a measuring point for nitrogen oxides and oxygen.

### SUMMARY OF THE INVENTION

The present invention is based on the object of improving a measuring device of the abovementioned type.

According to the invention, a measuring device is provided for dust in flue gas, by which samples of the dust are taken. The measuring device comprises a housing with a sampling arrangement for continuously sampling of the dust to provide withdrawn samples and at least one sensor. The sensor is arranged in the housing for obtaining measuring data of the withdrawn samples, the sensor being sensitive for gas which arrives in the housing accumulated on the dust.

According to another aspect of the invention, a process is provided for measuring dust in flue gas. The process comprises providing the measuring device by which samples of the dust are taken and continuously withdrawing samples of the dust with the measuring device to separate gas accumulated on the dust and to obtain measuring data both from the gas and from the degassed dust.

The gas contained in the flue gas are accumulated partly in the gas phase and partly on the dust, i.e. the dust contains fixed particles and accumulated (gas) particles. The gases result from the combustion in the fireplace plant, or are added subsequently, as in the event of denitration plants, to which ammonia or urea is added. In order to recognize (and to avoid) a slippage of the added gases, I. e. an excess, generic measuring devices are used. The known measuring devices mainly examine the gas phase. For the examination of the dust samples are taken and examined externally (i.e. “offline”).

The sensor is provided for an alternative examination of the dust: It examines the atoms, molecules (for example ammonia) or other particles accumulated on the dust, shortly called accumulated gas, by means of the sensor which is sensitive for this gas. Before the examination the measuring device preferably separates the accumulated gas from the dust, preferably by supplying energy. While the sensor delivers quantitative measuring data of the separated gas, measuring data of the degassed dust can be obtained by means of a balance.

By means of the sampling arrangement of the measuring device according to the invention, samples of the dust can be taken, the dust being filtered out of the flue gas by a separation filter. The dust (being used for taking the samples) can be collected in a collecting area of the separation filter.

While the sampling arrangement of the measuring device during operation continuously withdraws samples of the dust, also continuously measuring data is delivered, i.e. the examination of the dust with accumulated gas is done “online”. This measuring data can enter into a control circuit, for example of the denitration plant or the whole combustion plant. With variations of the sensor the invention can be used in various stationary thermodynamic plants, particularly power plants, incinerators and cement works.

In the following the invention is explained more in detail on the basis of an embodiment represented in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 a schematic view through an embodiment of the measuring device according to the invention;

FIG. 2 a partial view of the embodiment of FIG. 1; and

FIG. 3 a schematic diagram of a denitration plant with the embodiment of the measuring device according to the invention.

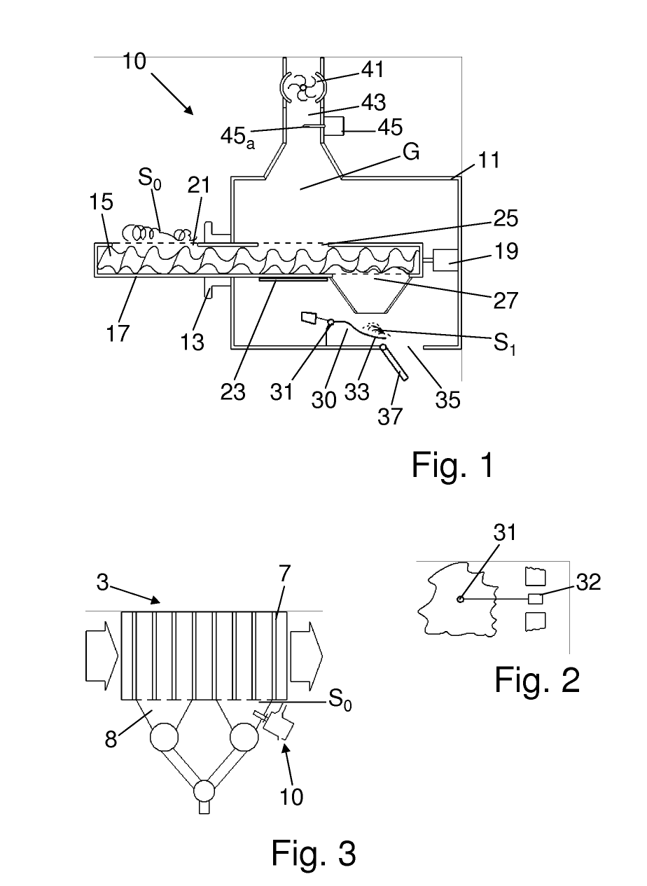

### DESCRIPTION OF THE PREFERRED EMBODIMENTS

Referring to the drawings in particular, in a combustion plant, particularly a coal, oil or gas power plant, an incinerator or a cement plant, the flue gas resulting in the furnace on the way to the chimney is led through a denitration plant 3. By injection of ammonia (or urea), as a reduction material, the nitrogen oxides that are to be reduced (chemically). When the temperature is too low and/or the stoichiometry between reduction material and oxidant is not right, there is a slippage, i.e. after the reaction unconsumed ammonia remains. The latter is partly contained in gaseous form in the flue gas and partly accumulated on the particles in the flue gas, here designated as dust S₀. The dust S₀ is in particular fly ash from the combustion region of the furnace. At a separation filter 7, for example an electrostatic filter, the dust S₀ is filtered out of the flue gas and collected in a collecting area 8. The dust S₀ can be reused for example in cement manufacturing.

In order to determine the ammonia content in the flue gas, the gaseous part is measured directly. For determining the part accumulated on the dust S₀, in the state of the art a sample is collected, which undergoes a wet digestion in order to measure the concentration of the ammonia, the sample is then heated in order to expel the ammonia, and again undergoes a wet digestion in order to measure the concentration of the ammonia again, which is then ideally zero. The difference gives the slippage of the ammonia, as far as it is accumulated on the dust S₀. This sampling is carried out roughly every eight hours and therefore cannot be used for an online control of the denitration plant 3 or of the combustion in the furnace.

According to the invention a measuring device 10 is provided, which, from the dust S₀, rapidly determines the ammonia content so that the result can be used for a control of the combustion in the furnace.

The measuring device 10 includes a housing 11, which is preferably provided with a flange 13. The measuring device 10 is arranged in the denitration plant 3 in the collecting area 8, preferably fixed with the flange 13 at a wall of the collecting area 8. The measuring device 10 comprises a sampling arrangement with a conveyer, particularly a screw conveyor 15. The screw conveyor 15 is mounted in a tube 17, which is arranged partly inside the case 11 and partly protrudes out of the housing 11 and into the interior of the collecting area 8. A motor 19 arranged in the housing 11, the number of revolutions of which is adjustable, rotates the screw conveyor 15. The tube 17 includes various windows and slots. One of these windows, I. e. the intake 21, is situated outside the case 11. Part of the dust S₀ arrives through the intake 21 onto the screw conveyor 15 and is transported by it into the case 11.

Inside the case 11 on the bottom of the pipe 17 there is a heat supply 23 (or another power supply) and above it a gas opening 25. When supplying the withdrawn dust S₀ with energy, gas G hitherto accumulated, in this case ammonia, separates from the dust S₀ and escapes.

If the dust S₀, after the separation of the gas G, degassed dust S₁ remains, which through a dust opening 27 falls out of the tube 17 and arrives on a balance 30. The balance 30, which is based on the principle of a beam balance, is pivoted around a shaft 31 and normally is balanced out. With the shaft 31 a flag 32 is non-rotatably connected, for example outside the case 11. When the degassed dust S₁ arrives on the balance 30, more precisely in a scale 33 of the same, the shaft 31 rotates and deflects the flag 32. The deflection of the flag 32 is measured, preferably inductively. The degassed dust S₁ slides from the scale 33 downwards and falls through an outlet 35 which can be closed by a flap 37. The integral over the time-dependent deflection of the flag 32 is a measure for the mass flow of the degassed dust S₁.

The formerly accumulated gas G is taken in by an aspirator 41, i.e. by a power-operated fan wheel. The aspirator 41 sucks the gas G into a suction pipe 43, in which a sensor 45 protrudes, preferably by means of a probe 45a. The balance 30 and the sensor 45 form the measuring means of the measuring device 10, by means of which measuring data of the sample continuously withdrawn during operation are obtained. The sensor 45 operates according to an operating principle known per se, in which molecules of the gas G deposit on the surface of the probe 45a (or another part of the sensor 45). By a capacitive measurement the kind and the amount of the deposited molecules of the gas G can be determined, i.e. a qualitative and quantitative measurement is possible. The sensor 45 in this case is set for ammonia. Behind the aspirator 41 the gas G can leave the measuring device 10.

The measuring data of the balance 30 and of the sensor 45 depend among others on the rotational speed of the motor 19. In order to calibrate the measuring device 10, the measuring data of the balance 30 and of the sensor 45 are compared to the measuring data from the known external samplings and analyses. Apart from an original calibration as for the rotational speed of the motor 19 and other parameters of the measuring device 10 thus a repeated calibration of the measuring device 10 is possible, in which the intervals (on an average for example eight hours) with increasing working life can also be longer (for example up to a day). The measuring data from the known external samplings and analyses are preferably fed into a computer to which the measuring device 10 is connected and from which it retrieves these measuring data for the calibration, i.e. the calibration is done online (without operator).

Between calibrations, the measuring device 10, during operation, continuously takes samples from the dust S₀ and continuously delivers measuring data that give conclusions on the current ammonia content in the dust S₀. In combination with measuring data from the measurement of the gaseous content in the flue gas, conclusions on the whole as to the current ammonia content result. With this measuring data therefore a control of the denitration plant 3 is possible (and of the combustion in the furnace), which can react promptly on changes of the ammonia content. The measuring device 10 is a component of a corresponding control circuit.

The measuring device 10 can be sensitive for other gases by means of other sensors 45, which by means of supply from energy can be expelled out of the withdrawn dust S₀.

While specific embodiments of the invention have been shown and described in detail to illustrate the application of the principles of the invention, it will be understood that the invention may be embodied otherwise without departing from such principles.

What is claimed is:

1. A measuring device for dust in flue gas, by which samples of the dust are taken, the measuring device comprising:
a housing with a sampling arrangement for continuously sampling of the dust to provide withdrawn samples; and
at least one sensor arranged in the housing for obtaining measuring data of the withdrawn samples, the sensor being sensitive for gas which arrives in the housing accumulated on the dust.

2. A measuring device according to claim 1, wherein the sampling arrangement separates operation accumulated gas from the dust to obtain measuring data both from the gas and from the degassed dust.

3. A measuring device according to claim 2, wherein the sampling arrangement comprises a heating or power supply to separate the accumulated gas from the dust.

4. A measuring device according to claim 2, wherein the sampling arrangement includes a balance to obtain measuring data of the degassed dust, a deflection of the balance being measured by a flag at the balance.

5. A measuring device according to claim 2, wherein the sensor provides quantitative measuring data of the gas and the sampling arrangement comprises an aspirator to suck the gas to the sensor.

6. A measuring device according to claim 1, wherein the sampling arrangement includes a screw conveyor or another conveyer in order to continuously take the samples of the dust and to convey the samples of the dust to an interior of the housing.

7. A measuring device according to claim 6, wherein the screw conveyor is mounted in a tube, which has an intake for the withdrawal of the dust, at least one gas opening for the escape of gas and at least one dust opening for the precipitation of degassed dust.

8. A measuring device according to claim 1, wherein the measuring device is a component of a control circuit for controlling a denitration plant and/or is sensitive for ammonia as a gas.

9. A measuring device according to claim 1, further comprising an external sampling and sample analyses for providing original and/or repeated external sampling and sample analyses.

10. A measuring device according to claim 4 wherein:
the sampling arrangement includes a screw conveyor or another conveyer in order to continuously take the samples of the dust and to convey the samples of the dust to an interior of the housing; and
the screw conveyor is mounted in a tube, which has an intake for the withdrawal of the dust, at least one gas opening for the escape of gas and at least one dust opening for the precipitation of degassed dust, the dust opening being disposed such that the degassed dust falls on the balance.

11. A process for measuring dust in flue gas, the process comprising the steps of:
providing a measuring device by which samples of the dust are taken, the measuring device comprising a housing with a sampling arrangement for continuously sampling of the dust to provide withdrawn samples and at least one sensor arranged in the housing for obtaining measuring data of the withdrawn samples, the sensor being sensitive for gas which arrives in the housing accumulated on the dust; and
continuously withdrawing samples of the dust with the measuring device to separate gas accumulated on the dust and to obtain measuring data both from the gas and from the degassed dust.

12. A process according to claim 11, wherein the sampling arrangement separates operation accumulated gas from the dust to obtain measuring data both from the gas and from the degassed dust.

13. A process according to claim 12, wherein the sampling arrangement comprises a heating or power supply to separate the accumulated gas from the dust.

14. A process according to claim 12, wherein the sampling arrangement includes a balance to obtain measuring data of the degassed dust, a deflection of the balance being measured by a flag at the balance.

15. A process according to claim 12, wherein the sensor provides quantitative measuring data of the gas and the sampling arrangement comprises an aspirator to suck the gas to the sensor.

16. A process according to claim 11, wherein the sampling arrangement includes a screw conveyor or another conveyer in order to continuously take the samples of the dust and to convey the samples of the dust to an interior of the housing.

17. A process according to claim 14, wherein:
the sampling arrangement includes a screw conveyor or another conveyer in order to continuously take the samples of the dust and to convey the samples of the dust to an interior of the housing; and
the screw conveyor is mounted in a tube, which has an intake for the withdrawal of the dust, at least one gas opening for the escape of gas and at least one dust opening for the precipitation of degassed dust, the dust opening being disposed such that the degassed dust falls on the balance.

18. A process according to claim 11, wherein the measuring device is a component of a control circuit for controlling a denitration plant and/or is sensitive for ammonia as a gas.

19. A process according to claim 11, further comprising an external sampling and sample analyses for providing original and/or repeated external sampling and sample analyses.

20. A plant comprising:
a furnace with a flue conveying flue gas;
a dust separation arrangement to remove dust out of the flue gas and collect the dust in a collecting area;
a measuring device for dust in flue gas, by which samples of the dust are taken from the collecting area, the measuring device comprising a housing with a sampling arrangement for continuously sampling of the dust to provide withdrawn samples and at least one sensor arranged in the housing for obtaining measuring data of the withdrawn samples, the sensor being sensitive for gas which arrives in the housing accumulated on the dust.
